(19) United States
(12) Patent Application Publication
(10) Pub. No.: US 2012/0051442 A1
(43) Pub. Date: Mar. 1, 2012

(54) Video Processor Configured to Correct Field Placement Errors in a Video Signal

(76) Inventors: Sarah J. Cristarella, Gillette, NJ (US); Diego P. deGarrido, Newtown, PA (US); Timothy J. Purkey, Kempton, PA (US)

(21) Appl. No.: 12/872,000

(22) Filed: Aug. 31, 2010

(51) Int. Cl. H04N 7/26

(52) U.S. Cl. 375/240.27; 375/E07.279

(57) ABSTRACT

A video processor or other processing device incorporates functionality for correcting field placement errors in a video signal. The device obtains at least a portion of a current frame of a video signal, and compares a designated field of an adjacent frame of the video signal with a designated field of the current frame. If the designated field of the adjacent frame and the designated field of the current frame are of the same polarity, the device adjusts a field display configuration value of the current frame, and the current frame is displayed in accordance with the adjusted field display configuration value. However, if the designated field of the adjacent frame and the designated field of the current frame are of different polarities, the current frame is displayed without adjusting the field display configuration value. This process is repeated for each of one or more additional frames of the video signal. The device may comprise, for example, a video processor integrated circuit implemented in a digital video player.

### FIELD OF THE INVENTION

The present invention relates generally to digital video signal processing, and more particularly to techniques for correcting field placement errors in conjunction with decoding of interlaced video.

### BACKGROUND OF THE INVENTION

A frame of an interlaced video signal typically includes two separate fields, referred to as top and bottom fields. The top field contains every other scan line beginning with the first scan line. The bottom field contains every other scan line beginning with the second scan line. In other words, the top field comprises the odd horizontal scan lines, and the bottom field comprises the even horizontal scan lines. A video display scans or draws all the top field lines, followed by all the bottom field lines, in an interlaced fashion. Hence, a display controller should provide the top and bottom fields to the display in strict alternation. The “top” and “bottom” characterization of a given field is also referred to herein as the “polarity” of the field.

A digital video signal encoded in accordance with well-known video compression standards such as MPEG or H.264 may also be in an interlaced format. Such a signal is typically encoded in a manner that preserves the desired alternating field sequence. For example, in the MPEG context, an encoder will generally utilize top-field-first and repeat-first-field flags associated with each frame to ensure that the last field of a given frame has the opposite polarity as the first field of the next frame. In other words, if the current frame of an encoded signal ends on a bottom field, the next frame should start on a top field, and vice-versa. The corresponding decoder utilizes these flags to determine how to place the fields of the frame in order to provide proper conversion while maintaining the alternating pattern of fields.

However, a problem can arise when video streams from different sources are concatenated, spliced or otherwise combined. This can occur, for example, when commercial advertisements are inserted into broadcast television programs, or when clips from different movies are spliced into a single video signal. Such combinations of sets of frames from different sources can break the desired alternating field sequence, causing the last field of a given frame to have the same polarity as the first field of the next frame, rather than the desired opposite polarity. This condition is also referred to herein as a frame insertion error, or more generally as a field placement error. Errors of this type can lead to significant artifacts in the displayed video. For example, noticeable distortion can result from sustained field inversion, where the bottom field is displayed on the odd lines and the top field is displayed on the even lines. If the decoder attempts to avoid field inversion by reversing the time order of the top and bottom fields, temporal distortion occurs, which can lead to motion on the display becoming jerky.

Known techniques for correcting field placement errors in interlaced video are disclosed in U.S. Pat. No. 6,118,491, entitled “System and Method for Enforcing Interlaced Field Synchronization in the Presence of Broken Alternation in an MPEG Video Datastream,” which is commonly assigned herewith and incorporated by reference herein. In one MPEG embodiment disclosed therein, upon detection of a field placement error in a given frame, the logic states of the top-field-first and repeat-first-field flags are both reversed or “flipped” in the following frame in order to address the error. Other known techniques involve looking ahead one frame in order to detect the presence of a field placement error, and then adding an extra top or bottom field to the previous frame in order to maintain the alternating field sequence.

Although the above-noted techniques address the field placement error correction problem, further improvements are needed. For example, the look-ahead technique mentioned above always adds a field to the previous frame when there is a field polarity conflict between adjacent frames, even if a field has already been added to that frame, resulting in the addition of unnecessary fields to the video signal. Accordingly, a need exists for an improved approach to correction of field placement errors in video signal decoding applications.

### SUMMARY OF THE INVENTION

Illustrative embodiments of the present invention overcome the above-noted drawbacks of conventional practice by providing improved techniques for correction of field placement errors in video signal decoding applications.

In accordance with one aspect, a video processor or other processing device incorporates functionality for correcting field placement errors in a video signal. The device obtains at least a portion of a current frame of a video signal, and compares a designated field of an adjacent frame of the video signal with a designated field of the current frame. If the designated field of the adjacent frame and the designated field of the current frame are of the same polarity, the device adjusts a field display configuration value of the current frame, and the current frame is displayed in accordance with the adjusted field display configuration value. However, if the designated field of the adjacent frame and the designated field of the current frame are of different polarities, the current frame is displayed without adjusting the field display configuration value. This process is repeated for each of one or more additional frames of the video signal. The device may comprise, for example, a video processor integrated circuit implemented in a digital video player.

In one of the illustrative embodiments with look-ahead, the adjacent frame comprises a next frame of the video signal, the designated field of the adjacent frame comprises a first field of the next frame, and the designated field of the current frame comprises a last field of the current frame. The first field of the next frame of the video signal is compared with the last field of the current frame. If the first field of the next frame and the last field of the current frame are of the same polarity, a field display configuration value of the current frame is adjusted, and the current frame is displayed in accordance with the adjusted field display configuration value. However, if the first field of the next frame and the last field of the current frame are of different polarities, the current frame is displayed without adjusting the field display configuration value.

In one of the illustrative embodiments without look-ahead, the adjacent frame comprises a previous frame of the video signal, the designated field of the adjacent frame comprises a last field of the previous frame, and the designated field of the current frame comprises a first field of the current frame. The last field of the previous frame of the video signal is compared with the first field of the current frame. If the last field of the previous frame and the first field of the current frame are of the same polarity, a field display configuration value of the current frame is adjusted, and the current frame is displayed in accordance with the adjusted field display configuration value. However, if the last field of the previous frame and the first field of the current frame are of different polarities, the current frame is displayed without adjusting the field display configuration value.

The illustrative embodiments of the invention provide a number of significant advantages over the conventional techniques previously described. For example, look-ahead embodiments of the invention avoid adding unnecessary frames to the video signal. Also, certain embodiments of the invention are applicable to a variety of different video compression standards, including both MPEG and H.264 standards. In certain MPEG embodiments, the above-noted field display configuration value may comprise a repeat field flag (e.g., repeat_first_field), while in certain H.264 embodiments, the field display configuration value may comprise picture structure setting information (e.g., pic_struct).

### BRIEF DESCRIPTION OF THE DRAWINGS

FIG. 1 is a block diagram of a digital video processing system comprising a digital video player that includes a video processor having field placement error correction functionality in an illustrative embodiment.

FIG. 2 is a more detailed view of the digital video player of the FIG. 1 system.

FIG. 3 is a flow diagram of a field placement error correction process performed by a video processor in an MPEG embodiment of the invention.

FIG. 4 is a flow diagram of a field placement error correction process performed by a video processor in a first H.264 embodiment of the invention.

FIG. 5 shows picture structure setting information used in H.264 embodiments of the invention.

FIG. 6 illustrates the manner in which picture structure setting values are modified in accordance with the FIG. 4 process.

FIG. 7 is a flow diagram of a field placement error correction process performed by a video processor in a second H.264 embodiment of the invention.

FIG. 8 illustrates the manner in which picture structure setting values are modified in accordance with the FIG. 7 process.

### DETAILED DESCRIPTION OF THE INVENTION

The invention will be illustrated herein in conjunction with an exemplary digital video processing system which includes a digital video player having field placement error correction functionality configured in a particular manner. It should be understood, however, that the invention is more generally applicable to any video processing application in which it is desirable to provide improved correction of field placement errors.

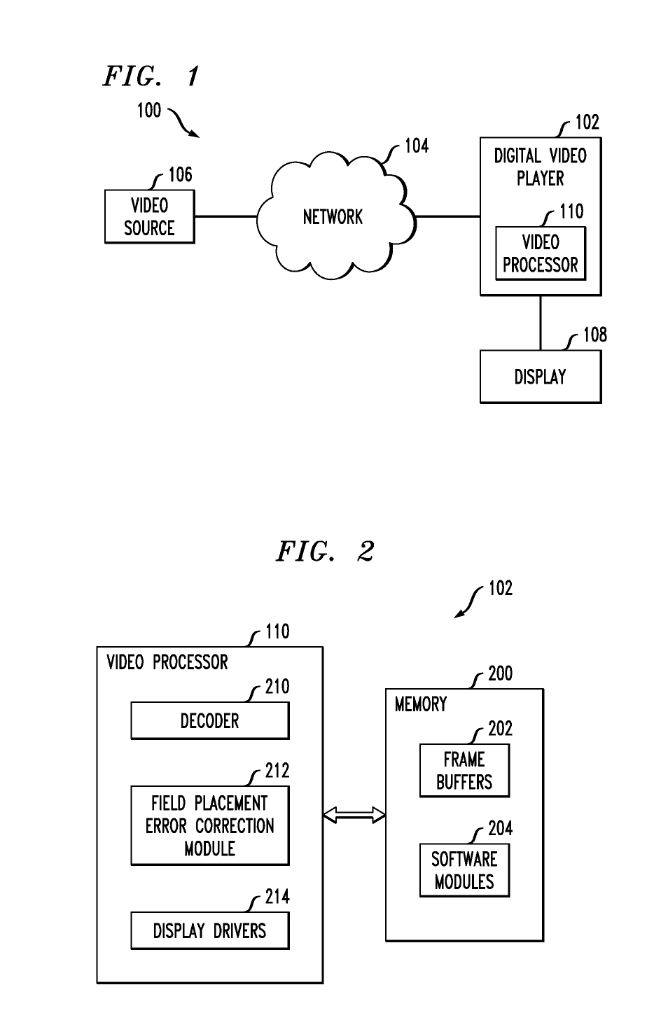

FIG. 1 shows a network-based digital video processing system 100 in an illustrative embodiment of the invention. The system 100 includes a digital video player 102 coupled via a network 104 to a video source 106. The digital video player 102 receives a compressed video signal from video source 106 over network 104, and processes the video signal for presentation on a display 108. This processing occurs in a video processor 110, and generally involves decoding the compressed video signal, and configuring it for appropriate display. In other embodiments, the video signal to be displayed need not be received over a network, but could instead be stored locally within the digital video player or an associated storage device, or retrieved from a disk or other storage medium inserted into the digital video player. Accordingly, the network 104 may be eliminated in other embodiments.

The processing performed by the video processor 110 may include conventional operations such as 3:2 pulldown in order to convert video transmitted or stored at 24 frames per second to video at 30 frames per second suitable for presentation on a television or similar display. For example, video retrieved from a DVD generally has a frame rate of 24 frames per second, and may be converted to a frame rate of 30 frames per second using 3:2 pulldown in the video processor 110. Typically, 3:2 pulldown involves repeating a designated field in every other frame of the video signal to be converted, such as repeating the first field subsequent to the second field in every other frame.

The network 104 may comprise, for example, a local area network (LAN), a metropolitan area network (MAN), a wide area network (WAN), the Internet, a cable network, a cellular network, a satellite network, as well as portions or combinations of these or other types of networks. Thus, the video source 106 may illustratively comprise a server, a base station, a satellite, a cable head end, etc.

It is assumed for purposes of describing the illustrative embodiments that the video to be displayed is interlaced video, which is to be displayed on display 108 as a series of alternating top and bottom fields. The video may be encoded in accordance with well-known compression standards such as MPEG or H.264. The MPEG standards include MPEG-2, described in International Standard ISO/IEC 2-13818, “Generic coding of moving pictures and associated audio information,” which is incorporated by reference herein. The H.264 standard is described in ITU-T Recommendation H.264, “Advanced video coding for generic audiovisual services,” March 2005, which is incorporated by reference herein.

The digital video player 102 may be a separate stand-alone unit designed for connection to a television or other separate display monitor. Alternatively, the digital video player may be a computer, a mobile telephone, a digital video recorder (DVR), a set-top-box or any other communication or processing device configured to process a video signal for display, or a portion of such a communication or processing device. In one or more such devices, the display 108 may be integrated with the digital video player 102 into a single unit. As indicated previously, the invention does not require that the video signal processed by digital video player 102 be received over a network.

FIG. 2 shows a more detailed view of the digital video player 102. In this embodiment, the digital video player comprises a memory 200 which includes frame buffers 202 for storing frames of a video signal to be processed for display. The memory 200 also stores software modules 204 that may be utilized by the video processor 110. The video processor 110 includes a decoder 210, a field placement error correction module 212, and display drivers 214. Although the field placement error correction module 212 is shown as being separate from the decoder 210 and display drivers 214 in this embodiment, it may alternatively be incorporated into one of these elements, or implemented in a distributed manner across multiple such elements. For example, the decoder 210 may be configured to incorporate the functionality of the field placement error correction module 212. Also, the module 212 may be implemented at least in part in the form of software that is retrieved from memory 200 for execution by the video processor 110.

The video processor 110 and its associated memory 200 may be implemented, by way of example and without limitation, utilizing a microprocessor, central processing unit (CPU), digital signal processor (DSP), application-specific integrated circuit (ASIC), field-programmable gate array (FPGA), or other type of data processing device, as well as portions or combinations of these and other devices. For example, one or more of the elements 200, 210, 212 and 214 may each be implemented as a separate integrated circuit or alternatively multiple such elements may be combined into a single integrated circuit.

The memory 200 may be viewed as an example of what is more generally referred to herein as a “computer program product” having executable computer program code embodied therein. The computer program code when executed in video processor 110 via field placement error correction module 212 causes the processor to perform field placement error correction operations such that the video signal supplied to display 108 includes the desired alternating field sequence. Other examples of computer program products embodying aspects of the invention may include, for example, optical or magnetic disks.

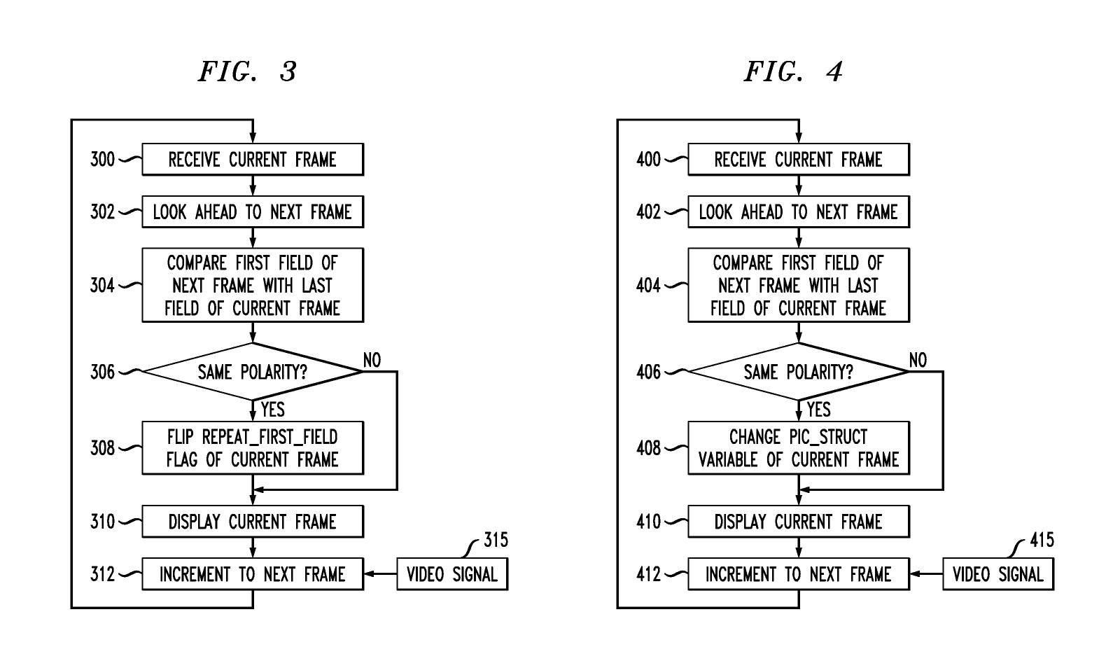

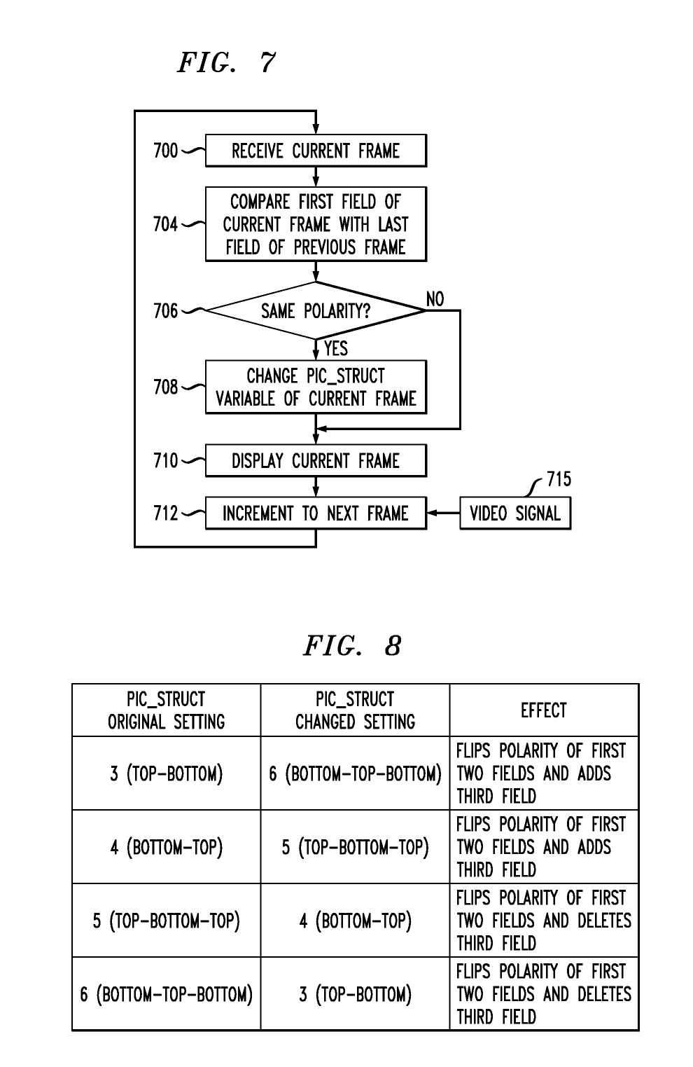

FIGS. 3, 4 and 7 are flow diagram of exemplary field placement error correction processes performed by video processor 110 in illustrative embodiments of the invention. The embodiments shown in FIGS. 3 and 4 are respective MPEG and H.264 embodiments with look-ahead. In these two embodiments, the process looks ahead one frame for any conflict in the desired alternating placement of fields, and if conflict is observed, a field is added to or subtracted from the current frame to maintain alternating top and bottom fields. The embodiment shown in FIG. 7 is an H.264 embodiment without look-ahead. In this third embodiment, the process compares the current frame with the preceding frame for any conflict in the desired alternating placement of fields, and if conflict is observed, the respective polarities of the first two fields of the current frame are reversed or “flipped” and a field is added to or subtracted from the current frame to maintain alternating top and bottom fields. It should be noted that, although these embodiments utilize MPEG or H.264 standards, other embodiments of the invention can be implemented in a straightforward manner using other video coding standards.

In each of the embodiments illustrated in FIGS. 3, 4 and 7, a current frame of a video signal is obtained, and a designated field of an adjacent frame of the video signal is compared with a designated field of the current frame. The term “comparing” in this context is intended to be broadly construed, and may encompass, for example, simply comparing the polarities of the respective fields. If the designated field of the adjacent frame and the designated field of the current frame are of the same polarity, a field display configuration value of the current frame is adjusted, and the current frame is displayed in accordance with the adjusted field display configuration value. However, if the designated field of the adjacent frame and the designated field of the current frame are of different polarities, the current frame is displayed without adjusting the field display configuration value. Examples of the above-noted “field display configuration value” include a repeat field flag (e.g., repeat_first_field) of the current frame, as in the MPEG embodiment of FIG. 3, or a picture structure setting (e.g., pic_struct) of the current frame, as in the H.264 embodiments of FIGS. 4 and 7. The comparing and displaying process is repeated for additional frames of the video signal.

Referring now to FIG. 3, an MPEG embodiment with look-ahead is shown, and includes steps 300 through 312. A video signal 315 is applied as input to step 312 of the process. In step 300, a current frame of the video signal is received, and in step 302, the process looks ahead to the next frame of the video signal. In step 304, the first field of the next frame of the video signal is compared with the last field of the current frame. Step 306 then determines whether or not the two compared fields have the same polarity. If the first field of the next frame and the last field of the current frame are of the same polarity, the repeat_first_field flag of the current frame is flipped, as indicated in step 308. More specifically, the binary logic value of the repeat_first_field flag of the current frame is inverted, i.e., changed from logic “0” to logic “1” or vice-versa. The current frame is then displayed in step 310 using the adjusted repeat_first_field flag from step 308. However, if the first field of the next frame and the last field of the current frame are not of the same polarity, the current frame is displayed in step 310 without adjusting the repeat_first_field flag of that frame. The process then increments to the next frame of the video signal 315, as indicated in step 312, and steps 300 through 310 are repeated for that frame.

Thus, in the FIG. 3 embodiment, as video frames are received, the video processor 110 looks ahead to the next frame and compares it to the current frame to be displayed. If the last field of the current frame has the same polarity as the first field of the next frame, the repeat_first_field flag of the current frame is flipped, either adding a field to or subtracting a field from the current frame as needed to maintain alternating frame polarity.

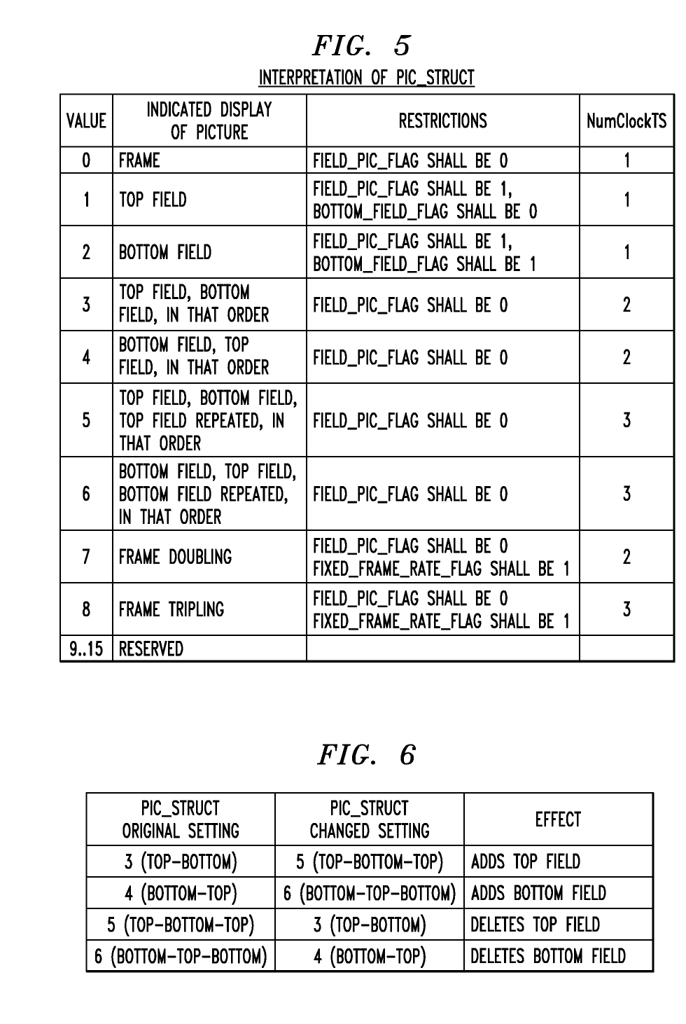

A corresponding H.264 embodiment of the FIG. 3 process is shown in FIG. 4. Process blocks 400, 402, 404, 406, 410, 412 and 415 of the FIG. 4 diagram are generally the same as the respective blocks 300, 302, 304, 306, 310, 312 and 315 of the FIG. 3 diagram. However, in the FIG. 4 embodiment, step 408 involves adjusting a picture structure setting variable (e.g., pic_struct) of the current frame, rather than adjusting a repeat_first_field flag as in the FIG. 3 embodiment. FIG. 5 shows a table illustrating the interpretation of the pic_struct variable as specified in the H.264 standard. See ITU-T Recommendation H.264, March 2005, at page 286.

FIG. 6 illustrates the particular manner in which the pic_struct variable values are modified in step 408 of the FIG. 4 process. In terms of the particular values, original pic_struct values of 3, 4, 5 and 6 are changed to values of 5, 6, 3 and 4, respectively. This means that, for example, if the original picture structure setting of the current frame has a value indicating a top-bottom field display configuration, it is changed in step 408 to a value indicating a top-bottom-top field display configuration. Alternatively, if the original picture structure setting of the current frame has a value indicating a bottom-top field display configuration, it is changed in step 408 to a value indicating a bottom-top-bottom field display configuration. As another possibility, if the original picture structure setting of the current frame has a value indicating a top-bottom-top field display configuration, it is changed in step 408 to a value indicating a top-bottom field display configuration. Finally, if the original picture structure setting of the current frame has a value indicating a bottom-top-bottom field display configuration, it is changed in step 408 to a value indicating a bottom-top field display configuration.

As noted above, FIG. 7 shows an H.264 embodiment without look-ahead. The process includes steps 700 through 712. A video signal 715 is applied as input to step 712 of the process. In step 700, a current frame of the video signal is received, and in step 704, the last field of the previous frame of the video signal is compared with the first field of the current frame. Step 706 then determines whether or not the two compared fields have the same polarity. If the last field of the previous frame and the first field of the current frame are of the same polarity, the pic_struct variable of the current frame is adjusted, as indicated in step 708. The current frame is then displayed in step 710 using the adjusted pic_struct variable from step 708. However, if the last field of the previous frame and the first field of the current frame are of different polarities, the current frame is displayed in step 710 without adjusting the pic_struct variable of the current frame. The process then increments to the next frame of the video signal 715, as indicated in step 712, and steps 700 through 710 are repeated for that frame.

Thus, in the FIG. 7 embodiment, as video frames are received, the video processor 110 compares the first field of the current frame to the last field of the previous frame. If the two fields have the same polarity, the pic_struct variable of the current frame is changed. This generally involves flipping the polarity of the first two fields and either adding a field to or subtracting a field from the current frame as needed to maintain alternating frame polarity.

FIG. 8 illustrates the particular manner in which the pic_struct variable values are modified in step 708 of the FIG. 7 process. In terms of the particular values, original pic_struct values of 3, 4, 5 and 6 are changed to values of 6, 5, 4 and 3, respectively. This means that, for example, if the original picture structure setting of the current frame has a value indicating a top-bottom field display configuration, it is changed in step 708 to a value indicating a bottom-top-bottom field display configuration. Alternatively, if the original picture structure setting of the current frame has a value indicating a bottom-top field display configuration, it is changed in step 708 to a value indicating a top-bottom-top field display configuration. As another possibility, if the original picture structure setting of the current frame has a value indicating a top-bottom-top field display configuration, it is changed in step 708 to a value indicating a bottom-top field display configuration. Finally, if the original picture structure setting of the current frame has a value indicating a bottom-top-bottom field display configuration, it is changed in step 708 to a value indicating a top-bottom field display configuration.

The illustrative embodiments described above provide a number of significant advantages over conventional techniques. For example, look-ahead embodiments of the invention avoid adding unnecessary fields to the video signal, thereby reducing jitter and other undesirable artifacts. Moreover, these techniques do not add or subtract complete frames to or from the video signal. Also, certain embodiments of the invention are applicable to a variety of different video compression standards, including both MPEG and H.264 standards

It is to be appreciated that the particular processes shown in FIGS. 3, 4 and 7 are presented by way of illustrative example only, and that alternative embodiments may use other types, orderings and arrangements of process steps.

As indicated previously, a video processor 110 configured in accordance with the invention may be implemented as one or more integrated circuits. A given such integrated circuit may be installed, for example, on a printed circuit board or other support structure within digital video player 102.

In a given integrated circuit implementation, identical die are typically foiined in a repeated pattern on a surface of a semiconductor wafer. Each die includes a video processor or other device as described herein, and may include other structures or circuits. The individual die are cut or diced from the wafer, then packaged as an integrated circuit. One skilled in the art would know how to dice wafers and package die to produce integrated circuits. Integrated circuits so manufactured are considered part of this invention.

Again, it should be emphasized that the embodiments of the invention as described herein are intended to be illustrative only. For example, the particular arrangement of system elements as shown in FIG. 1 may be varied in alternative embodiments. Also, other types of circuitry and software in any combination may be used to implement field placement error correction operations as disclosed herein. These and numerous other alternative embodiments within the scope of the following claims will be readily apparent to those skilled in the art.

What is claimed is:

1. A method comprising:
obtaining at least a portion of a current frame of a video signal;
comparing a designated field of an adjacent frame of the video signal with a designated field of the current frame;
if the designated field of the adjacent frame and the designated field of the current frame are of the same polarity, adjusting a field display configuration value of the current frame, and displaying the current frame in accordance with the adjusted field display configuration value; and
if the designated field of the adjacent frame and the designated field of the current frame are of different polarities, displaying the current frame without adjusting the field display configuration value.

2. The method of claim 1 wherein said obtaining, comparing, and displaying with or without adjusting are repeated for each of one or more additional frames of the video signal.

3. The method of claim 1 wherein the adjacent frame comprises a next frame of the video signal, the designated field of the adjacent frame comprises a first field of the next frame, and the designated field of the current frame comprises a last field of the current frame, such that said comparing and displaying with or without adjusting comprise:
comparing the first field of the next frame of the video signal with the last field of the current frame;
if the first field of the next frame and the last field of the current frame are of the same polarity, adjusting a field display configuration value of the current frame, and displaying the current frame in accordance with the adjusted field display configuration value; and
if the first field of the next frame and the last field of the current frame are of different polarities, displaying the current frame without adjusting the field display configuration value.

4. The method of claim 3 wherein the field display configuration value of the current frame comprises a repeat field flag of the current frame.

5. The method of claim 4 wherein adjusting the field display configuration value of the current frame comprises adjusting a value of a repeat first field flag of the current frame.

6. The method of claim 5 wherein adjusting the value of the repeat first field flag of the current frame comprises inverting a binary logic value of the repeat first field flag of the current frame.

7. The method of claim 3 wherein the field display configuration value of the current frame comprises a picture structure setting of the current frame, and wherein adjusting the field display configuration value of the current frame comprises adjusting a value of the picture structure setting of the current frame.

8. The method of claim 7 wherein adjusting the value of the picture structure setting of the current frame comprises one of:
changing the picture structure setting from a value indicating a top-bottom field display configuration to a value indicating a top-bottom-top field display configuration;
changing the picture structure setting from a value indicating a bottom-top field display configuration to a value indicating a bottom-top-bottom field display configuration;
changing the picture structure setting from a value indicating a top-bottom-top field display configuration to a value indicating a top-bottom field display configuration; and
changing the picture structure setting from a value indicating a bottom-top-bottom field display configuration to a value indicating a bottom-top field display configuration.

9. The method of claim 1 wherein the adjacent frame comprises a previous frame of the video signal, the designated field of the adjacent frame comprises a last field of the previous frame, and the designated field of the current frame comprises a first field of the current frame, such that said comparing and displaying with or without adjusting comprise:
comparing the last field of a previous frame of the video signal with the first field of the current frame;
if the last field of the previous frame and the first field of the current frame are of the same polarity, adjusting a field display configuration value of the current frame, and displaying the current frame in accordance with the adjusted field display configuration value; and
if the last field of the previous frame and the first field of the current frame are of different polarities, displaying the current frame without adjusting the field display configuration value.

10. The method of claim 9 wherein the field display configuration value of the current frame comprises a picture structure setting of the current frame, and adjusting the field display configuration value of the current frame comprises adjusting a value of the picture structure setting of the current frame.

11. The method of claim 10 wherein adjusting the value of the picture structure setting of the current frame comprises one of:
changing the picture structure setting from a value indicating a top-bottom field display configuration to a value indicating a bottom-top-bottom field display configuration;
changing the picture structure setting from a value indicating a bottom-top field display configuration to a value indicating a top-bottom-top field display configuration;
changing the picture structure setting from a value indicating a top-bottom-top field display configuration to a value indicating a bottom-top field display configuration; and
changing the picture structure setting from a value indicating a bottom-top-bottom field display configuration to a value indicating a top-bottom field display configuration.

12. The method of claim 1 wherein the video signal is encoded in accordance with an MPEG standard.

13. The method of claim 1 wherein the video signal is encoded in accordance with an H.264 standard.

14. A computer program product having executable computer program code embodied therein, wherein the computer program code when executed in a processing device causes the device to perform the steps of the method of claim 1.

15. An apparatus comprising:
a processing device comprising a memory, the memory including a frame buffer configured to store at least a portion of one or more frames of a video signal, the video signal including at least a current frame and an adjacent frame;
wherein the processing device further comprises a video processor operative to compare a designated field of the adjacent frame of the video signal with a designated field of the current frame of the video signal, and if the designated field of the adjacent frame and the designated field of the current frame are of the same polarity, to adjust a field display configuration value of the current frame, and to control display of the current frame in accordance with the adjusted field display configuration value, but if the designated field of the adjacent frame and the designated field of the current frame are of different polarities, to control display of the current frame without adjusting the field display configuration value.

16. The apparatus of claim 15 wherein the adjacent frame comprises a next frame of the video signal, the designated field of the adjacent frame comprises a first field of the next frame, and the designated field of the current frame comprises a last field of the current frame.

17. The apparatus of claim 15 wherein the adjacent frame comprises a previous frame of the video signal, the designated field of the adjacent frame comprises a last field of the previous frame, and the designated field of the current frame comprises a first field of the current frame.

18. The apparatus of claim 15 wherein the processing device comprises a digital video player.

19. A video processor comprising:
a decoder configured to process frames of a video signal, the video signal including at least a current frame and an adjacent frame; and
a display driver configured to deliver frames processed by the decoder for presentation on a display;
wherein the video processor further comprises a field placement error correction module operative to compare a designated field of the adjacent frame of the video signal with a designated field of the current frame of the video signal;
wherein if the designated field of the adjacent frame and the designated field of the current frame are of the same polarity, the video processor is operative to adjust a field display configuration value of the current frame, and to control display of the current frame in accordance with the adjusted field display configuration value; and
wherein if the designated field of the adjacent frame and the designated field of the current frame are of different polarities, the video processor is operative to control display of the current frame without adjusting the field display configuration value.

20. The video processor of claim 19 wherein the video processor is implemented in the form of an integrated circuit.
